(19) United States
(12) Patent Application Publication
(10) Pub. No.: US 2026/0296450 A1
(43) Pub. Date: Oct. 1, 2026

(54) VEHICLE, ESTIMATION METHOD, AND NON-TRANSITORY COMPUTER-READABLE STORAGE MEDIUM

(71) Applicant: HONDA MOTOR CO., LTD., Tokyo (JP)

(72) Inventors: Fumiaki YOSHIKAWA, Tokyo (JP); Osamu TAKAHATA, Tokyo (JP)

(73) Assignee: HONDA MOTOR CO., LTD., Tokyo (JP)

(21) Appl. No.: 19/095,053

(22) Filed: Mar. 31, 2025

(51) Int. Cl. B60W 40/12; B60K 35/28; B60W 50/14; G06V 20/56

(52) U.S. Cl. CPC B60W 40/12; B60K 35/28; B60W 50/14; G06V 20/56; B60W 2420/403; B60W 2552/15; B60W 2554/4044

(57) ABSTRACT

A processor of a vehicle for towing a trailer estimates a relative yaw angle of the trailer relative to the vehicle. The processor specifies a trajectory of a detection object in a trailer image, and determines whether the specified trajectory matches a reference trajectory. In a case where the specified trajectory matches the reference trajectory, the processor estimates an angle determined according to a position of the detection object on the trajectory, as the relative yaw angle. In a case where the specified trajectory does not match the reference trajectory, the processor determines that a second road surface on which the trailer is located is inclined relative to a first road surface on which the vehicle is located, and estimates, as the relative yaw angle, an angle obtained by performing slope correction on an angle determined according to a position of the detection object on the specified trajectory.

### TECHNICAL FIELD

The present invention relates to a vehicle for towing a trailer, an estimation method for a relative yaw angle of the trailer relative to the vehicle, and a non-transitory computer-readable storage medium storing a program causing a processor to perform the estimation method.

### BACKGROUND ART

In recent years, active efforts have been made to provide access to a sustainable transportation system in consideration of vulnerable people among traffic participants. In order to implement the above, research and development on further improving safety and convenience of traffic by research and development related to driving assistance technology have been performed.

A trailer trajectory estimation system described in the description of US2016/0098604A captures an image of a trailer coupled to a rear portion of a vehicle, uses the captured image to estimate a coupling angle of the trailer, and displays the estimated coupling angle.

A system described in the description of US2021/0380109A estimates a change rate of a hitch angle between a trailer and a vehicle based on rotation angles of a plurality of rear wheels of the vehicle towing the trailer and a speed of the vehicle, and generates and displays a trajectory of the trailer based on the estimated change rate of the hitch angle.

A driver assistance described in JP2017-502867A obtains a speed vector at a rear portion of a host vehicle located in the vicinity of a trailer coupler and a speed vector at a front portion of the trailer located in the vicinity of the trailer coupler, determines whether a jackknife condition occurs based on the speed vector of the host vehicle and the speed vector of the trailer, and generates a warning signal when an occurrence of the jackknife condition is predicted. The speed vector of the host vehicle is obtained based on an acceleration, a steering angle, and the like of the host vehicle, and the speed vector of the trailer is obtained based on a trailer angle detected from an image obtained by imaging the trailer, and the like.

A towing assistance device described in JP2019-199150A captures an image of a marker provided on a towed vehicle with an in-vehicle camera of a towing vehicle, converts the captured image into an overhead image in a plan view from above, and obtains a bending angle of the towed vehicle relative to the towing vehicle based on a position of the marker in the overhead image.

The trajectory or behavior of the trailer is estimated based on the coupling angle (also referred to as the hitch angle, the trailer angle, and the bending angle) of the trailer. The coupling angle is typically estimated by detecting the marker of the trailer captured in the image obtained by imaging the trailer.

### SUMMARY OF INVENTION

An object of the present invention is to efficiently estimate a coupling angle of a trailer from an image obtained by imaging the trailer, which hence contributes to development of a sustainable transportation system.

A first aspect of the present disclosure relates to a vehicle for towing a trailer includes:

a camera configured to acquire a trailer image containing a detection object provided on the trailer;

a sensor configured to acquire travel state information of the vehicle; and

a processor configured to estimate a relative yaw angle of the trailer relative to the vehicle, based on at least one of the trailer image or the travel state information,

in which in the estimation of the relative yaw angle based on the trailer image, the processor is configured to:

specify a trajectory of the detection object, which moves according to a change in the relative yaw angle, in the trailer image;

determine whether the specified trajectory matches a predetermined reference trajectory;

in a case where the specified trajectory matches the reference trajectory, estimate an angle determined according to a position of the detection object on the trajectory, as the relative yaw angle; and

in a case where the specified trajectory does not match the reference trajectory, determine that a second road surface on which the trailer is located is inclined relative to a first road surface on which the vehicle is located, and estimate, as the relative yaw angle, an angle obtained by performing slope correction on an angle determined according to a position of the detection object on the specified trajectory.

A second aspect of the present disclosure relates to a method of estimating a relative yaw angle of a trailer relative to a vehicle towing the trailer,

in which a processor performs the method having:

causing a camera provided in the vehicle to acquire a trailer image containing a detection object provided on the trailer;

causing a sensor provided in the vehicle to acquire travel state information of the vehicle; and

estimating the relative yaw angle based on at least one of the trailer image or the travel state information, and

in which in the estimation of the relative yaw angle based on the trailer image, the processor performs:

specifying a trajectory of the detection object, which moves according to a change in the relative yaw angle, in the trailer image;

determining whether the specified trajectory matches a predetermined reference trajectory;

in a case where the specified trajectory matches the reference trajectory, estimating an angle determined according to a position of the detection object on the trajectory, as the relative yaw angle; and

in a case where the specified trajectory does not match the reference trajectory, determining that a second road surface on which the trailer is located is inclined relative to a first road surface on which the vehicle is located, and estimating, as the relative yaw angle, an angle obtained by performing slope correction on an angle determined according to a position of the detection object on the specified trajectory.

A third aspect of the present disclosure relates to a non-transitory computer-readable storage medium storing a program causing a processor to perform the method of the second aspect.

### BRIEF DESCRIPTION OF DRAWINGS

Exemplary embodiments of the present invention will be described in detail based on the following figures, wherein:

FIG. 1 is a side view showing an example of a vehicle according to an aspect of the present invention;

FIG. 2 is a plan view of the vehicle of FIG. 1;

FIG. 3 is a functional block diagram of the vehicle of FIG. 1;

FIG. 4 is a flowchart of processing for detecting a detection object from a trailer image;

FIG. 5 is a schematic diagram showing a search range of a detection object in the detection processing of FIG. 4;

FIG. 6 is a schematic diagram showing a re-search range of the detection object in the detection processing of FIG. 4;

FIG. 7 is a schematic diagram showing a relationship between a slope of a road surface and a position of a marker within an angle of view of a camera that acquires a trailer image;

FIG. 8 is a schematic diagram showing a relationship between the slope of the road surface and the position of the marker within the angle of view of the camera that acquires the trailer image;

FIG. 9 is a schematic diagram showing a relationship between the slope of the road surface and the position of the marker within the angle of view of the camera that acquires the trailer image;

FIG. 10 is a schematic diagram showing a movement of the marker caused by the inclination of the road surface appearing in the trailer image;

FIG. 11 is a flowchart of processing of estimating a relative yaw angle based on the trailer image;

FIG. 12 is a graph illustrating slope correction of the relative yaw angle in the estimation processing of FIG. 11;

FIG. 13 is a graph illustrating the slope correction of the relative yaw angle in the estimation processing of FIG. 11; and

FIG. 14 is a schematic diagram showing an example of a display image of a prediction trajectory of the vehicle and a prediction trajectory of a trailer.

### DESCRIPTION OF EMBODIMENTS

Hereinafter, an example of a vehicle according to an aspect of the present invention will be described with reference to the accompanying drawings. The drawings are viewed from directions of reference numerals. In the present specification and the like, in order to simplify and clarify the description, a front-rear direction, a left-right direction, and an upper-lower direction are described according to directions viewed from a driver of a vehicle. In the drawings, a front side of the vehicle is shown as Fr, a rear side is shown as Rr, a left side is shown as L, a right side is shown as R, an upper side is shown as U, and a lower side is shown as D.

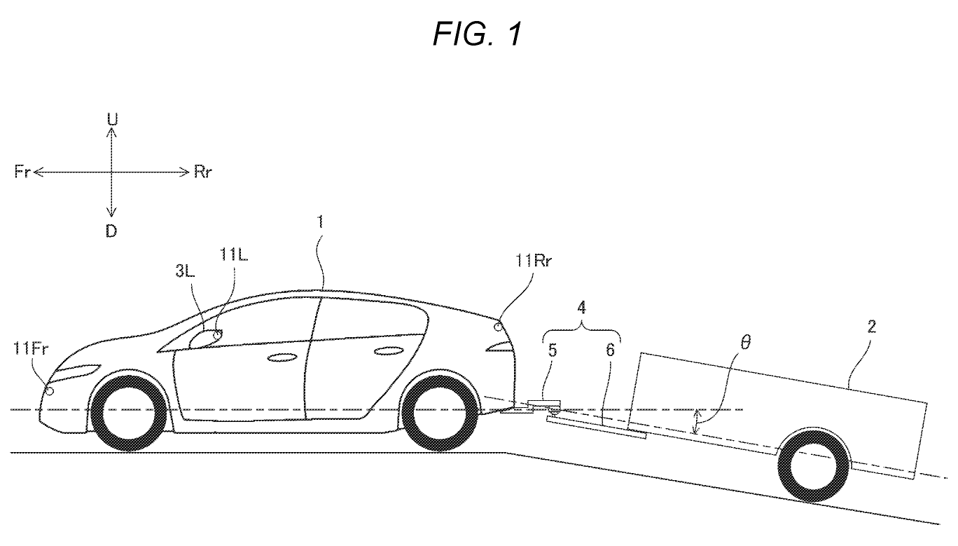

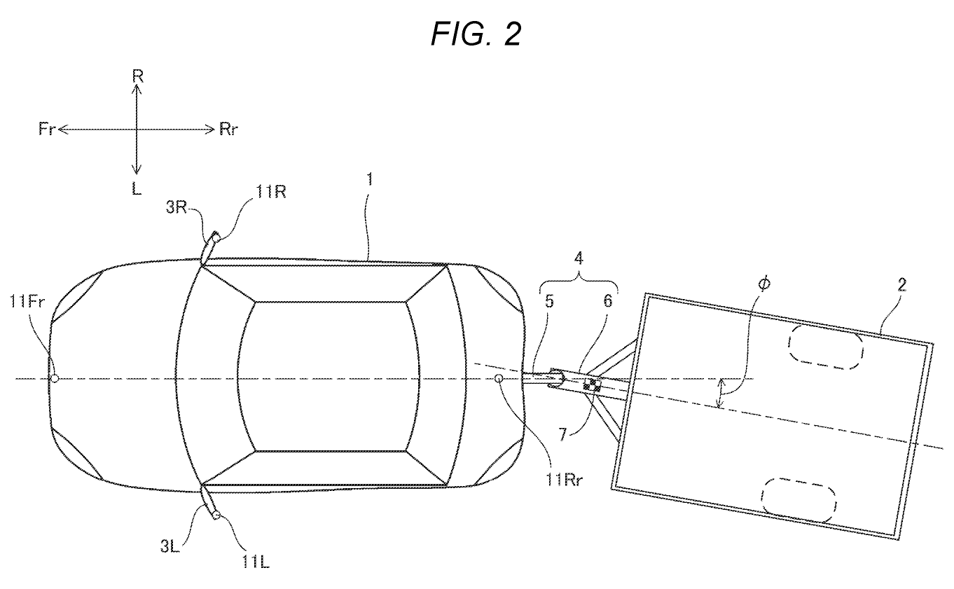

A vehicle 1 shown in FIGS. 1 and 2 is a four-wheel automobile including a pair of left and right front wheels and a pair of left and right rear wheels, and is an automobile capable of towing a trailer 2. A drive source of the vehicle 1 is an internal combustion engine such as a gasoline engine or a diesel engine, an electric motor, or a combination of the internal combustion engine and the electric motor. Both the pair of left and right front wheels and the pair of left and right rear wheels may be driven by the drive source, or any one of the pair of left and right front wheels and the pair of left and right rear wheels may be driven by the drive source. Alternatively, both the pair of left and right front wheels and the pair of left and right rear wheels may be steered wheels that are steerable, or any one of the pair of left and right front wheels and the pair of left and right rear wheels may be steered wheels.

The vehicle 1 includes side mirrors 3L and 3R. The side mirrors 3L and 3R are mirrors for a driver to check a rear side and rear lateral sides and are provided on outer sides of front seat doors of the vehicle 1.

The vehicle 1 includes a front camera 11Fr, a rear camera 11Rr, a left side camera 11L, and a right side camera 11R. The front camera 11Fr is a digital camera (image sensor) that images a front side of the vehicle 1 and is provided at a front portion of the vehicle 1. The rear camera 11Rr is a digital camera that images a rear side of the vehicle 1 and is provided on a rear portion of the vehicle 1. The left side camera 11L is a digital camera that images a left side of the vehicle 1 and is provided on the side mirror 3L on the left side of the vehicle 1. The right side camera 11R is a digital camera that images a right side of the vehicle 1 and is provided on the side mirror 3R on the right side of the vehicle 1.

The trailer 2 is coupled to the vehicle 1 via a coupling device 4. The coupling device 4 includes a vehicle arm 5 extending rearward from the rear portion of the vehicle 1, and a trailer arm 6 extending forward from a front portion of the trailer 2. The trailer 2 is coupled to the vehicle 1 by accommodating a hitch ball provided in the vehicle arm 5 into a coupler provided in the trailer arm 6.

The trailer 2 coupled to the vehicle 1 by the coupling device 4 is allowed to pitch, roll, and yaw relative to the vehicle 1. As shown in FIG. 1, an angle formed by an axle of the vehicle 1 and an axle of the trailer 2 when the vehicle 1 and the trailer 2 are viewed in a plan view in the left-right direction of the vehicle 1 is referred to as a relative pitch angle θ of the trailer 2 relative to the vehicle 1. As shown in FIG. 2, an angle formed by the axle of the vehicle 1 and the axle of the trailer 2 when the vehicle 1 and the trailer 2 are viewed in a plan view in the upper-lower direction of the vehicle 1 is referred to as a relative yaw angle φ of the trailer 2 relative to the vehicle 1.

A marker 7 serving as a detection object used for estimating the relative yaw angle is provided on an upper surface of the trailer arm 6. For example, the marker 7 may be provided in a form of a sticker, may be attached to the trailer arm 6, or may be provided by coating the trailer arm 6. The rear camera 11Rr of the vehicle 1 is installed on an upper side of the rear portion of the vehicle 1 to look down the trailer arm 6 from above. A rear image acquired by the rear camera 11Rr includes the trailer 2 including the marker 7 and a road surface.

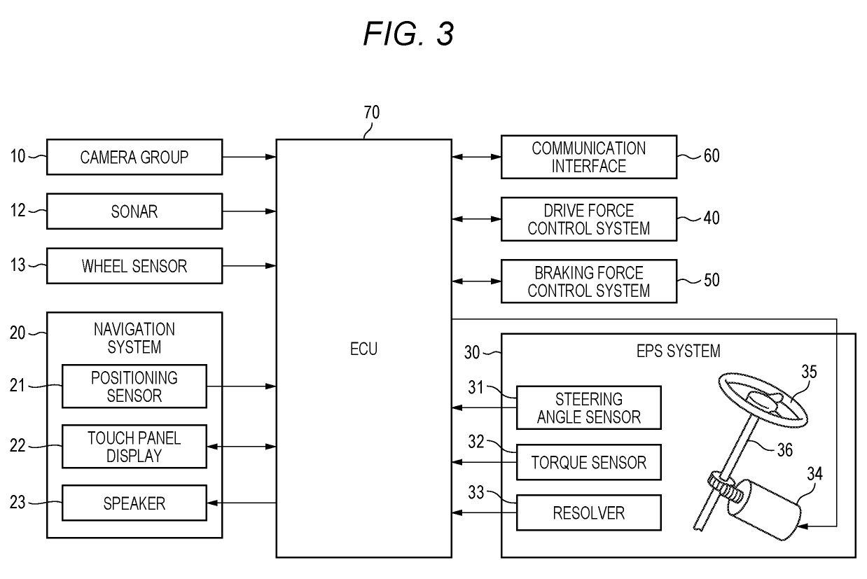

As shown in FIG. 3, the vehicle 1 includes a sensor group, a navigation system 20, an electric power steering (EPS) system 30, a drive force control system 40, a braking force control system 50, a communication interface 60, and an electronic control unit (ECU) 70 that integrally controls the devices.

The sensor group acquires various detection values used for control of the vehicle 1. A camera group 10 including the front camera 11Fr, the rear camera 11Rr, the left side camera 11L, and the right side camera 11R is also included in the sensor group. The sensor group further includes a sonar 12 for detecting an obstacle or the like present in the surroundings of the vehicle 1 and a wheel sensor 13 for acquiring information related to a travel state of the vehicle 1.

The front camera 11Fr, the rear camera 11Rr, the left side camera 11L, and the right side camera 11R acquire a front image, a rear image, a left side image, and a right side image of the vehicle 1. The ECU 70 generates a surrounding image of the vehicle 1 using images acquired by the front camera 11Fr, the rear camera 11Rr, the left side camera 11L, and the right side camera 11R. The surrounding image is, for example, a two-dimensional image or a three-dimensional image in which the vehicle 1 is overlooked. Images of the vehicle 1 and the trailer 2 prepared in advance may be combined with the surrounding image.

The sonar 12 emits sound waves to the surroundings of the vehicle 1 and receives a reflected sound. The ECU 70 detects an obstacle or the like present in the surroundings of the vehicle 1 based on a direction of the received reflected sound and a time from the emission of the sound waves to the reception of the reflected sound and detects a direction and a distance in which the obstacle or the like is present. The sensor group may include, as a sensor for detecting the obstacle or the like present in the surroundings of the vehicle 1, a sensor such as a radar or Lidar (Light Detection and Ranging or Laser Imaging Detection and Ranging) instead of the sonar 12 or in addition to the sonar 12.

The wheel sensor 13 detects rotation angles of the respective wheels including the pair of left and right front wheels and the pair of left and right rear wheels of the vehicle 1. The wheel sensor 13 is, for example, an angle sensor or a displacement sensor, and outputs a pulse signal each time the wheel rotates by a predetermined angle. The ECU 70 calculates the rotation angle and a rotation speed of each of the wheels from the pulse signal output from the wheel sensor 13 and further calculates a speed and a moving distance of the vehicle 1.

The navigation system 20 includes a positioning sensor 21 that detects a current position of the vehicle 1, a touch panel display 22, a speaker 23, and a memory (not shown) that stores map information. The positioning sensor 21 is, for example, a Global Positioning System (GPS) sensor. The navigation system 20 guides a travel route to a destination to an occupant of the vehicle 1 based on position information of the vehicle 1 detected by the positioning sensor 21 and the map information stored in the memory. The guidance is presented to the occupant through the touch panel display 22 or the speaker 23.

The touch panel display 22 functions as one of an input interface to the ECU 70 and an output destination of display processing and/or notification processing performed by the ECU 70. The speaker 23 functions as an output destination of notification processing performed by the ECU 70.

The EPS system 30 includes a steering angle sensor 31, a torque sensor 32, a resolver 33, and an EPS motor 34. The steering angle sensor 31 detects a steering angle of a steering wheel 35. The torque sensor 32 detects a torque applied to the steering wheel 35. The resolver 33 detects a rotation angle of the EPS motor 34. The ECU 70 drives the EPS motor 34 to apply a drive force or a reaction force to a steering column 36 coupled to the steering wheel 35 based on the steering angle, the torque, and the rotation angle, thereby assisting an operation of the occupant on the steering wheel 35.

Under the control of the ECU 70, the drive force control system 40 controls a drive force of the vehicle 1 by operating a drive source or the like of the vehicle 1 in response to an operation of the occupant on an accelerator pedal or the like. Under the control of the ECU 70, the braking force control system 50 controls a braking force of the vehicle 1 by operating a brake mechanism or the like of the vehicle 1 in response to an operation of the occupant on the brake pedal or the like.

The communication interface 60 performs wireless communication with another communication device under the control of the ECU 70. The other communication device is a base station, a communication device of another vehicle, an information terminal such as a smartphone carried by the occupant of the vehicle 1, or the like.

The ECU 70 includes a processor and a memory that stores programs to be executed by the processor and various types of data to be used during the execution of the programs. By the processor operating according to the programs, the ECU 70 realizes the various functions described above, such as the steering wheel operation assistance, the drive force control, and the braking force control. The ECU 70 can realize automated driving and automated parking based on cooperation of the sensor group, the navigation system 20, the EPS system 30, the drive force control system 40, and the braking force system 50. The ECU 70 may include a plurality of processors divided for respective functions such as the steering wheel operation assistance, the drive force control, and the braking force control.

The ECU 70 estimates the relative yaw angle φ of the trailer 2 based on at least one of the position information of the marker 7 in the trailer image, which is an image obtained by the rear camera 11Rr and contains the marker 7 of the trailer 2, or the travel state information of the vehicle 1 (that is, based on the position information, the travel state information, or both information). The travel state information is, for example, the steering angle detected by the steering angle sensor 31 and a wheel speed detected by the wheel sensor 13.

The ECU 70 detects the marker 7 in the trailer image using, for example, pattern matching. A template image of the marker 7 is registered in advance in the memory of the ECU 70. The ECU 70 detects an image that matches the template image or image locations that match features of the template image as the marker 7 in the trailer image. The marker 7 can be configured by, for example, a grid pattern including one or more grid points, and the grid points of the grid pattern can be feature points of the marker 7 and a template image thereof in pattern matching.

The marker 7 in a real space moves in an arc-shaped trajectory centered on the hitch ball of the coupling device 4 depending on a change in the relative yaw angle φ. Therefore, the marker 7 in the trailer image also moves along the arc-shaped trajectory. The ECU 70 specifies a position of the detected marker 7 on the arc-shaped trajectory in the trailer image, and estimates the relative yaw angle φ based on the specified position information of the marker 7.

Further, the relative yaw angle φ can be represented by an equation of motion in which a motion model created based on various specifications of the vehicle 1 and the trailer 2 is used and the steering angle and the wheel speed of the vehicle 1 are variables. The ECU 70 estimates a current relative yaw angle φ based on the relative yaw angle φ at a past time point and the travel state information including a current steering angle and wheel speed. In the estimation, for example, a Karman filter can be used.

Further, the relative yaw angle φ estimated based on the position information of the marker 7 and the relative yaw angle φ estimated based on the travel state information pass through the Karman filter, and thus accuracy of the relative yaw angle φ estimated based on the position information of the marker 7 can be improved using the relative yaw angle φ estimated based on the travel state information.

The ECU 70 basically adopts the relative yaw angle φ estimated based on the position information of the marker 7 as the relative yaw angle φ of the trailer 2, but in a case where the estimation based on the position information of the marker 7 cannot be performed, the relative yaw angle φ estimated based on the travel state information is adopted as the relative yaw angle φ of the trailer 2. Examples of the case where the estimation based on the position information of the marker 7 cannot be performed include a case where the marker 7 in the trailer image cannot be detected. Examples of factors that hinder the detection of the marker 7 include disappearance of the feature points of the marker 7 caused by a dirt adhered to the marker 7, reflection of a surface of the marker 7, and shadow reflected on the marker 7, and the marker 7 being is buried in markings of the road surface contained in the trailer image.

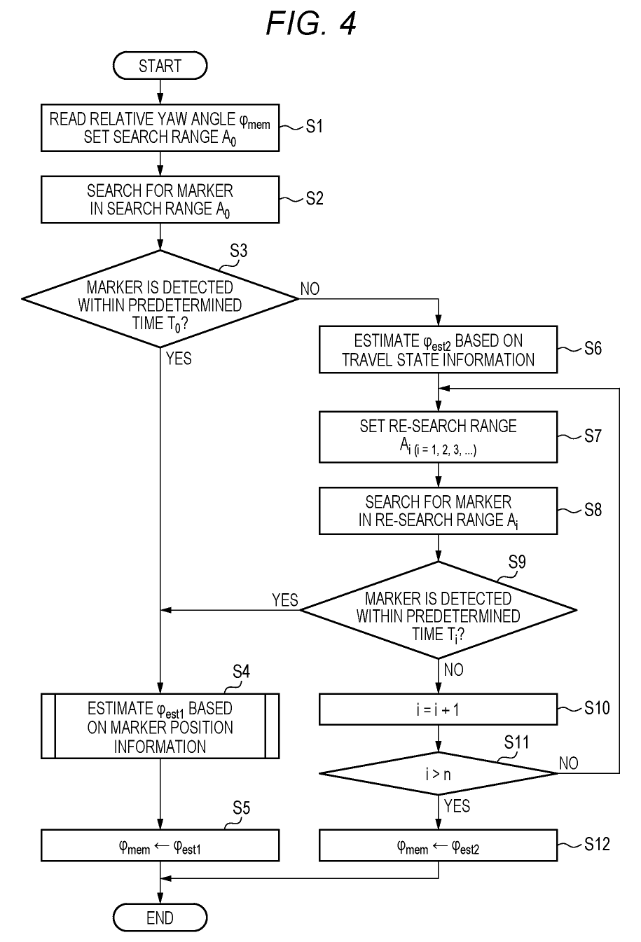

FIG. 4 shows processing for detecting the marker 7 from the trailer image, which is performed by the ECU 70.

Basically, the ECU 70 stores the relative yaw angle φ obtained by the estimation processing of the relative yaw angle φ executed immediately before in the memory, uses the relative yaw angle φₘₑₘ stored in the memory to set a search range of the marker 7 in the trailer image, and searches for the marker 7 in the trailer image. Immediately after an ignition of the vehicle 1 is turned on, that is, immediately after a vehicle system is started, the ECU 70 may search an entire range of the trailer image or an entire range of the arc-shaped trajectory of the marker 7 in the trailer image, but preferably, the relative yaw angle φ at a time point when the vehicle system is stopped in a previous travel is stored in the memory, the relative yaw angle φₘₑₘ stored in the memory is used to set a search range of the marker 7 in the trailer image, and the marker 7 is searched for.

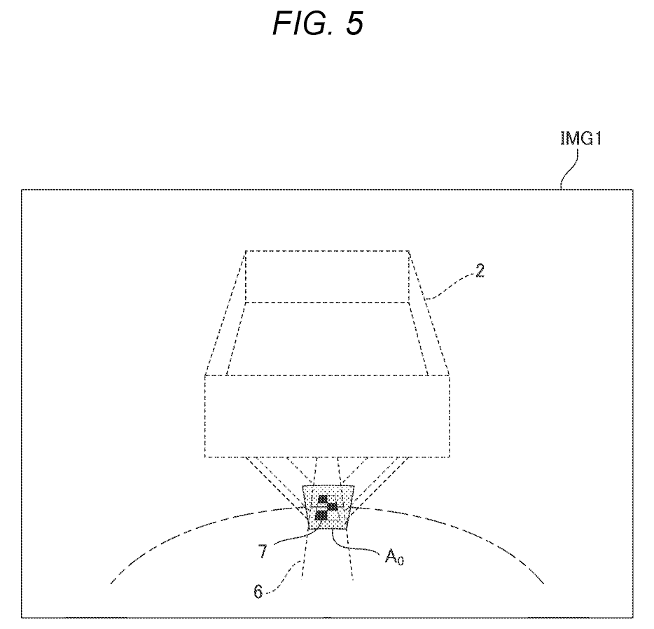

First, the ECU 70 reads the relative yaw angle φₘₑₘ stored in the memory, and sets the search range A₀ of the marker 7 in the trailer image using the relative yaw angle φₘₑₘ read from the memory (step S1). Referring to FIG. 5, the search range A₀ has the same size as an outline of the marker 7 in a trailer image IMG1, and the ECU 70 arranges the search range A₀ at a position corresponding to the relative yaw angle φₘₑₘ on the arc-shaped trajectory of the marker 7. The search range A₀ having the same size as the outline of the marker 7 may at least include the marker 7 and is preferably a fan shape concentric with the arc-shaped trajectory of the marker 7 and having a minimum size that can include the marker 7.

The ECU 70 attempts to detect the marker 7 in the search range A₀ set in the trailer image (step S2). When the marker 7 is detected within the search range A₀ before a time that has elapsed since the start of the search in the search range A₀ reaches a predetermined time T₀ (step S3: Yes), the ECU 70 specifies a position of the detected marker 7 on the arc-shaped trajectory in the trailer image and estimates the relative yaw angle φ based on the specified position information of the marker 7 (step S4). Then, the ECU 70 updates the relative yaw angle φₘₑₘ stored in the memory based on a relative yaw angle φₑₛₜ₁ estimated in step S3 (step S5) and ends the processing.

On the other hand, when the marker 7 cannot be detected within the search range A₀ before the time that has elapsed since the start of the search in the search range A₀ reaches the predetermined time T₀ (step S3: No), the ECU 70 estimates the current relative yaw angle φ based on the relative yaw angle φₘₑₘ stored in the memory and the travel state information including the current steering angle and wheel speed (step S6).

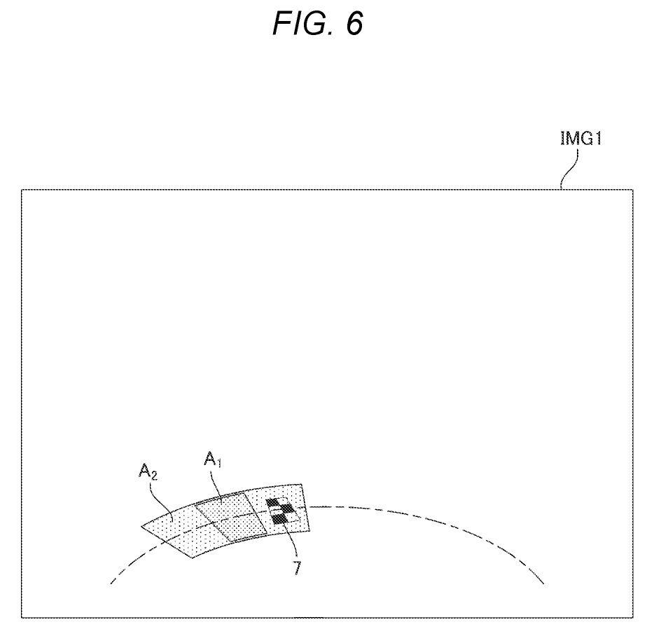

Next, the ECU 70 uses a relative yaw angle φₑₛₜ₂ estimated in step S6 to set a re-search range Aᵢ(i = 1, 2, 3, ...) of the marker 7 in the trailer image (step S7). Referring to FIG. 6, a size of the re-search range A₁ at the beginning of the re-search has the same size as the outline of the marker 7 in the trailer image IMG1, and the ECU 70 arranges the re-search range A₁ at a position corresponding to the relative yaw angle φₑₛₜ₂ on the arc-shaped trajectory of the marker 7. The re-search range A₁ having the same size as the outline of the marker 7 may at least include the marker 7 and is preferably a fan shape concentric with the arc-shaped trajectory of the marker 7 and having a minimum size that can include the marker 7.

Then, the ECU 70 attempts to detect the marker 7 in the re-search range Aᵢ set in step S6 (step S8). When the marker 7 is detected within the re-search range Aᵢ before a time that has elapsed since the start of the search in the re-search range Aᵢ reaches a predetermined time Tᵢ(i = 1, 2, 3, ...) (step S9: Yes), the ECU 70 shifts to step S4 and estimates the relative yaw angle φ based on the position information of the marker 7.

On the other hand, when the marker 7 cannot be detected within the re-search range Aᵢ before the time that has elapsed since the start of the search in the re-search range Aᵢ reaches the predetermined time Tᵢ (step S9: No), the ECU 70 expands the re-search range Aᵢ of the marker 7 from a previous re-search range Aᵢ₋₁ (step S10). As shown in FIG. 6, the re-search range Aᵢ of marker 7 may be expanded in both a first direction and a second direction along the arc-shaped trajectory of marker 7 in the trailer image IMG1, or may be expanded first in the first direction and then expanded in the second direction after reaching an end of the arc-shaped trajectory in the first direction. Then, the ECU 70 attempts to detect the marker 7 in the expanded re-search range Aᵢ. The predetermined time Tᵢ, which is the search time for the corresponding re-search range Aᵢ, may be constant and the same as the predetermined time T₀, which is the search time for the search range A₀, or may be gradually extended considering that the re-search range Aᵢ is expanded gradually.

When the marker 7 cannot be detected even if the detection of the marker 7 in the re-search range Aᵢ and the expansion of the re-search range Aᵢ are repeated a predetermined number of times n (step S11: No), the ECU 70 updates the relative yaw angle φₘₑₘ stored in the memory based on the relative yaw angle φₑₛₜ₂ estimated in step S5 (step S12), and ends the processing.

The ECU 70 periodically detects the marker 7.

In the detection processing of the marker 7 described above, first, it is attempted to detect the marker 7 in the search range A₀ set using the relative yaw angle φₘₑₘ stored in the memory, that is, the relative yaw angle φ obtained in the estimation processing of the relative yaw angle executed immediately before, and thus the marker 7 can be detected more efficiently than attempting to perform the detection in the entire range of the trailer image or the entire range on the arc-shaped trajectory of the marker 7. Further, when the marker 7 cannot be detected in the search range A₀, the relative yaw angle φₑₛₜ₂ estimated based on the relative yaw angle φₘₑₘ stored in the memory and the travel state information including the current steering angle θst and wheel speed is used to set the re-search range Aᵢ, and it is attempted to repeat the detection of the marker 7 while expanding the re-search range Aᵢ gradually, and thus the marker 7 can be detected more efficiently than attempting to perform the detection in the entire range of the trailer image or the entire range on the arc-shaped trajectory of the marker 7.

Then, it is attempted to detect the marker 7 within the range of the search range A₀ and the re-search range A₁ having the same size as the outline of the marker 7 and the re-search range Aᵢ gradually expanded from the re-search range A₁, it is possible to effectively reduce a possibility of erroneously detecting the markings on the road surface contained in the trailer image as the marker 7, and to improve detection accuracy of the marker 7.

Next, processing for estimating the relative yaw angle based on the trailer image by the ECU 70 will be described.

As described above, when the marker 7 is detected within the search range A₀ or the re-search range Aᵢ, the ECU 70 specifies a position of the detected marker 7 on the arc-shaped trajectory in the trailer image, and estimates the relative yaw angle φ based on the specified position information of the marker 7. The ECU 70 performs slope correction in the estimation processing.

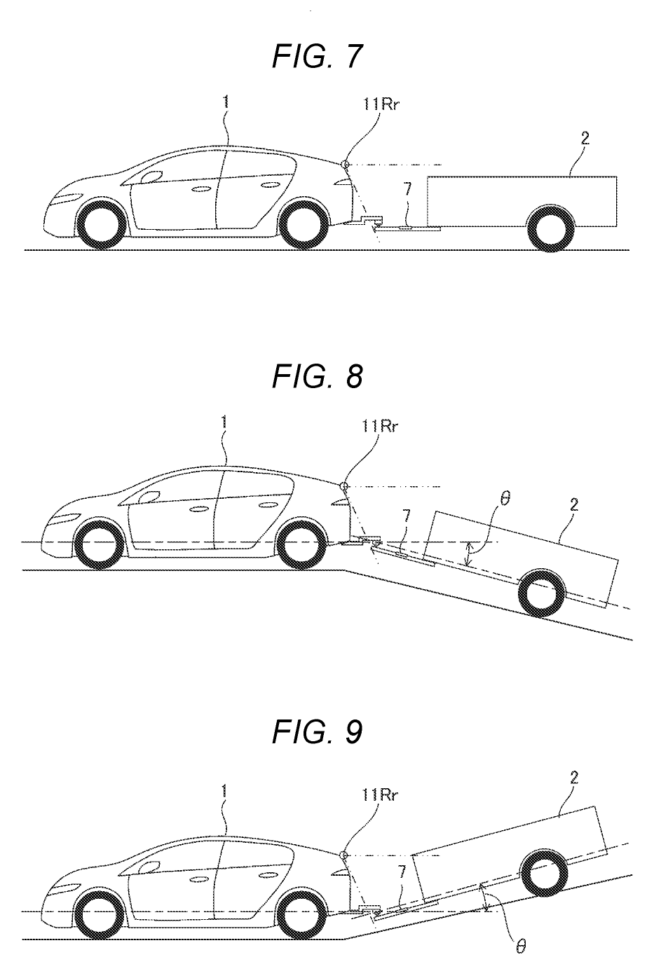

FIG. 7 shows a case where a gradient of a road surface on which the vehicle 1 is located and a gradient of a road surface on which the trailer 2 is located are the same, and the relative pitch angle θ of the trailer 2 relative to the vehicle 1 is 0°. FIG. 8 shows a case where the gradient of the road surface on which the trailer 2 is located is an upward gradient relative to the gradient of the road surface on which the vehicle 1 is located, and the relative pitch angle θ is a positive value. FIG. 9 shows a case where the gradient of the road surface on which the trailer 2 is located is a downward gradient relative to the gradient of the road surface on which the vehicle 1 is located, and the relative pitch angle is a negative value. In response to a change in the relative pitch angle θ, the marker 7 moves within an angle of view of the rear camera 11Rr that acquires the trailer image.

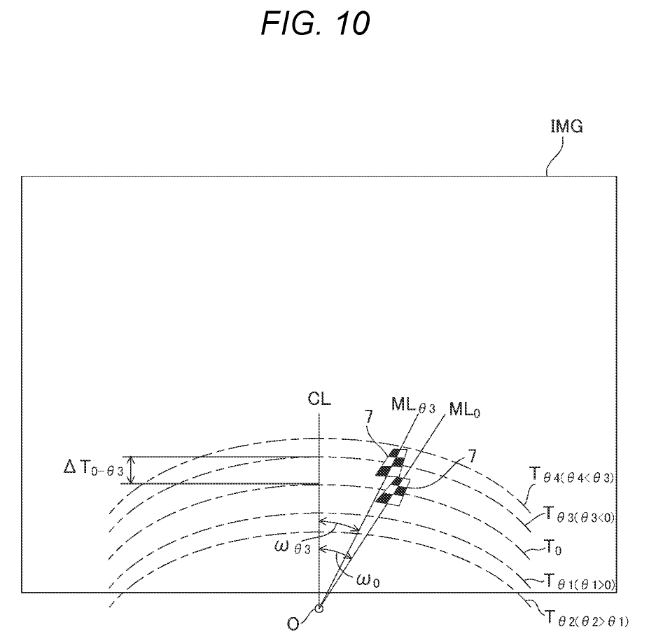

FIG. 10 schematically shows a movement on the arc-shaped trajectory of the marker 7 in the trailer image in relation to the relative pitch angle θ. The arc-shaped trajectory of the marker 7 in the trailer image corresponding to the change in the relative yaw angle φ moves up and down in the trailer image according to the change in the relative pitch angle θ. When the relative pitch angle θ is a positive value (FIG. 8) with the arc-shaped trajectory of the marker 7 when the relative pitch angle θ is 0° (FIG. 7) as a reference trajectory T₀, each of arc-shaped trajectories T_{θ1} and T_{θ2} of the marker 7 is offset downward relative to the reference trajectory T₀, and an offset amount thereof relates to an absolute value of the relative pitch angle θ. When the relative pitch angle θ is a negative value (FIG. 9), each of arc-shaped trajectories T_{θ3} and T_{θ4} of the marker 7 is offset upward relative to the reference trajectory T₀, and an offset amount thereof relates to the absolute value of the relative pitch angle θ.

When a center of the arc-shaped trajectory of the marker 7 in the trailer image, that is, a point corresponding to the hitch ball of the coupling device 4 is set as a center O, a line extending in an upper-lower direction of the image through the center O is set as a center line CL, and a line passing through the center O and a detected center position of the marker 7 is set as a marker line ML, the relative yaw angle φ is derived using a marker angle ω formed by the center line CL and the marker line ML. In the derivation of the relative yaw angle φ, for example, the angle of view of the rear camera 11Rr, image distortion caused by a lens of the rear camera 11Rr, and the like are considered.

Here, as shown in FIG. 10, even if the relative yaw angle φ is the same, the marker angle ω changes as the marker 7 moves up and down in response to the change in the relative pitch angle θ, and the relative yaw angle φ determined according to the marker angle ω also changes. The ECU 70 performs slope correction corresponding to the relative pitch angle θ on the relative yaw angle φ determined according to the marker angle ω.

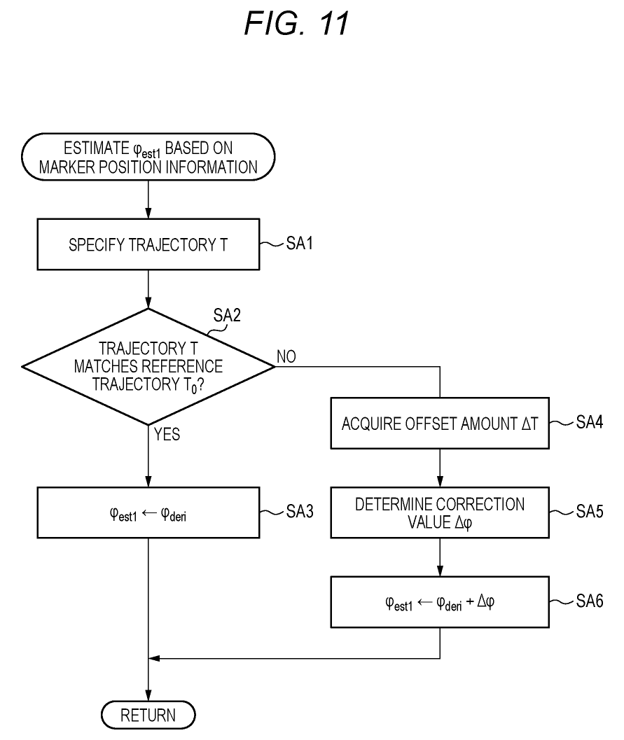

FIG. 11 shows the slope correction processing performed by the ECU 70.

First, the ECU 70 specifies the trajectory T of the marker 7 in the trailer image (step SA1).

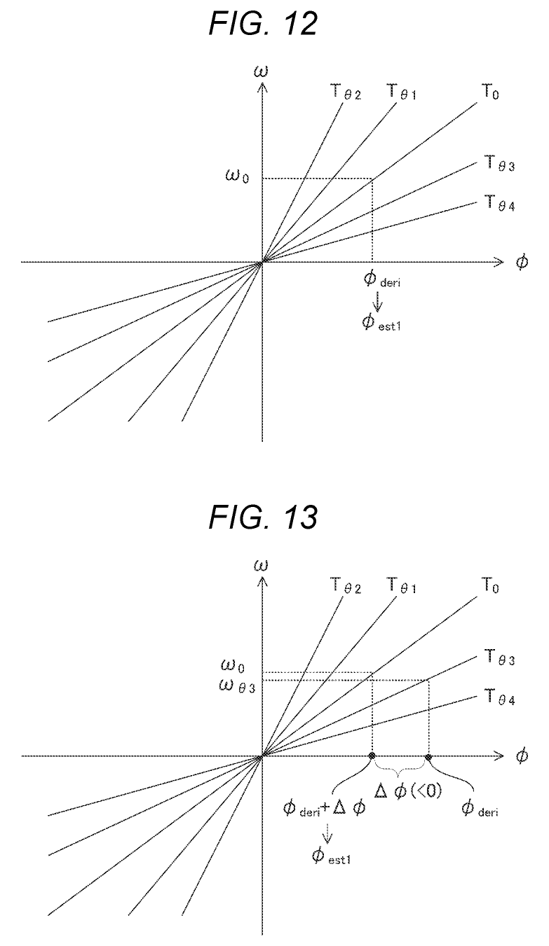

Referring to FIG. 12, when the specified trajectory T matches the reference trajectory T₀ (step SA2: Yes), ECU 70 determines that the relative pitch angle θ is 0°, that is, the road surface on which the trailer 2 is located is not inclined relative to the road surface on which the vehicle 1 is located. Without performing the slope correction on the relative yaw angle φ_{deri} derived from the marker angle ω, the ECU 70 sets the derived relative yaw angle φ_{deri} as the estimated relative yaw angle φₑₛₜ₁ (step SA3).

On the other hand, when the specified trajectory T does not match the reference trajectory T₀ (step SA2: No), the ECU 70 determines that the road surface on which the trailer 2 is located is inclined relative to the road surface on which the vehicle 1 is located. The ECU 70 performs slope correction on the relative yaw angle φ_{deri} derived from the marker angle ω. In the slope correction, the ECU 70 acquires an offset amount ΔT of the specified trajectory T with respect to the reference trajectory T₀ from the trailer image (step SA4). The offset amount ΔT can be, for example, an interval between the trajectory T and the reference trajectory T₀ on the center line CL.

Referring to FIG. 13, ECU 70 determines a correction value Δφ corresponding to offset amount ΔT (step SA5) and sets, as the estimated relative yaw angle φₑₛₜ₁, a relative yaw angle φ obtained by adding the correction value Δφ to the relative yaw angle φ_{deri} derived from the marker angle ω (step SA6). A relationship between the offset amount ΔT and the correction value Δφ is acquired in advance and stored in the memory of the ECU 70 in a form of a lookup table, a relational expression, or the like. The ECU 70 determines the correction value Δφ corresponding to the offset amount ΔT with reference to the lookup table, the relational expression, and the like stored in the memory.

Accuracy of the estimated relative yaw angle φₑₛₜ₁ can be improved by the slope correction described above. Thus, the trailer 2 can be accurately guided to an intended location in automated traveling or automated parking performed by the ECU 70.

The ECU 70 generates a prediction trajectory of the vehicle 1 and a prediction trajectory of the trailer 2 based on the relative yaw angle φ estimated by the above-described processing and the travel state information including the steering angle θst and the wheel speed. Then, the ECU 70 performs display processing for displaying the generated prediction trajectory of the vehicle 1 and/or the generated prediction trajectory of the trailer 2 on a display device. The display device is, for example, the touch panel display 22 of the navigation system 20, but may be a display of an information terminal such as a smartphone carried by the occupant of the vehicle 1.

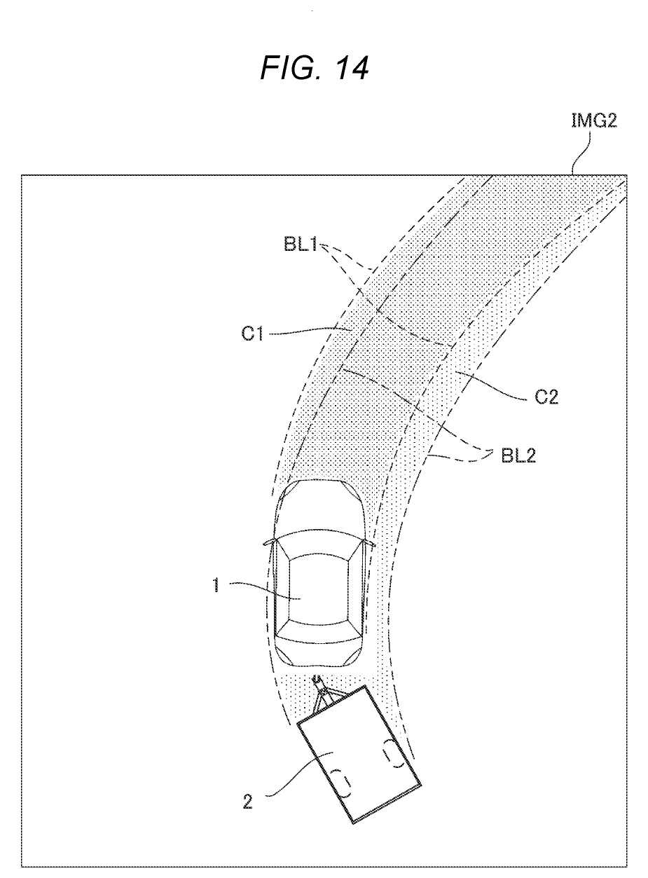

FIG. 14 shows an example of a display image displayed on the display device.

A display image IMG2 includes the surrounding image of the vehicle 1, a display element indicating the prediction trajectory of the vehicle 1, and a display element indicating the prediction trajectory of the trailer 2. As described above, the ECU 70 generates the surrounding image using the images acquired by the front camera 11Fr, the rear camera 11Rr, the left side camera 11L, and the right side camera 11R. In the shown example, the images of the vehicle 1 and the trailer 2 prepared in advance are combined with the surrounding image. The prediction trajectory of the vehicle 1 and the prediction trajectory of the trailer 2 are displayed to be superimposed on the surrounding image.

The display element indicating the prediction trajectory of the vehicle 1 and the display element indicating the prediction trajectory of the trailer 2 are, for example, a color attached to a region of the prediction trajectory or a boundary line of the region of the prediction trajectory. In the shown example, the prediction trajectory of the vehicle 1 is indicated by a color C1 and a boundary line L1 attached to a region thereof, but may be displayed only by the color C1 or only by the boundary line L1. Similarly, in the shown example, the prediction trajectory of the trailer 2 is indicated by a color C2 and a boundary line L2 attached to a region thereof, but may be displayed only by the color C2 or only by the boundary line L2.

The color C1 indicating the prediction trajectory of the vehicle 1 and the color C2 indicating the prediction trajectory of the trailer 2 are preferably transparent colors, and are the same color or similar colors. The "same color" refers to colors belonging to the same hue on a 12-hue circle or a 24-hue circle, and lightness and/or saturation may be different as long as the colors belong to the same hue. The "similar colors" refers to colors belonging to adjacent hues on the 12-hue circle or the 24-hue circle, and lightness and/or saturation may be different as long as the colors belong to adjacent hues.

Further, only one of the prediction trajectory of the vehicle 1 and the prediction trajectory of the trailer 2 may be displayed, for example, both the prediction trajectory of the vehicle 1 and the prediction trajectory of the trailer 2 may be displayed when the vehicle 1 moves forward, and only the prediction trajectory of the trailer 2 may be displayed when the vehicle 2 moves rearward. Furthermore, display/non-display of the prediction trajectory of the vehicle 1 and display/non-display of the prediction trajectory of the trailer 2 may be switched based on selection of the occupant of the vehicle 1.

The ECU 70 makes different display modes of the prediction trajectory of the trailer 2 between a case where the prediction trajectory is generated based on the relative yaw angle φ subjected to the slope correction and a case where the prediction trajectory is generated based on the relative yaw angle φ not subjected to the slope correction. A change of the display mode may be, for example, changing at least one of the hue, brightness, or saturation of the color C2 added to the region, switching between display and non-display of the boundary line L2, changing a line type of the boundary line L2, or a combination of these changes.

In this way, by changing the display mode of the prediction trajectory of the trailer 2 in the display image IMG2 based on the presence or absence of the slope correction, it is possible to call the attention of the occupant of the vehicle 1 regarding that the road surface on which the trailer 2 is located is inclined relative to the road surface on which the vehicle 1 is located, and it is possible to urge the occupant to perform careful steering.

When the prediction trajectory of the trailer 2 is generated based on the relative yaw angle φ subjected to the slope correction, the ECU 70 may perform other notification processing instead of or in addition to the change in the display mode of the prediction trajectory of the trailer 2 in the display image IMG2. As other notification processing, the ECU 70 may cause the touch panel display 22 to display text for calling the attention of the occupant, or may cause the speaker 23 to output a voice message. Further, the ECU 70 may transmit an instruction to an information terminal such as a smartphone carried by the occupant, and output the similar text, image, voice message, or the like from a touch panel display or a speaker of the information terminal.

The embodiment of the present invention has been described above, but the present invention is not limited to the embodiment described above, and modifications, improvements, and the like can be made as appropriate. In the present description, at least the following matters are described. Although corresponding constituent elements or the like in the above-described embodiment are shown in parentheses, the present invention is not limited thereto.

(1) A vehicle (vehicle 1) for towing a trailer (trailer 2), the vehicle including:

a camera (rear camera 11Rr) configured to acquire a trailer image (trailer image IMG1) containing a detection object (marker 7) provided on the trailer;

a sensor (wheel sensor group 13, steering angle sensor 31) configured to acquire travel state information of the vehicle; and

a processor (ECU 70) configured to estimate a relative yaw angle (relative yaw angle φ) of the trailer relative to the vehicle, based on at least one of the trailer image or the travel state information,

in which in the estimation of the relative yaw angle based on the trailer image, the processor is configured to:

specify a trajectory (trajectory T) of the detection object, which moves according to a change in the relative yaw angle, in the trailer image;

determine whether the specified trajectory matches a predetermined reference trajectory (reference trajectory T₀);

in a case where the specified trajectory matches the reference trajectory estimate an angle determined according to a position of the detection object on the trajectory, as the relative yaw angle; and

in a case where the specified trajectory does not match the reference trajectory, determine that a second road surface on which the trailer is located is inclined relative to a first road surface on which the vehicle is located, and estimate, as the relative yaw angle, an angle obtained by performing slope correction on an angle determined according to a position of the detection object on the specified trajectory.

According to the vehicle of the above (1), estimation accuracy of the relative yaw angle can be improved.

(2) The vehicle according to the above (1),

in which the reference trajectory is a trajectory of the detection object, which moves according to the change in the relative yaw angle, in the trailer image when a relative pitch angle (relative pitch angle θ) of the trailer relative to the vehicle is 0°, and

the processor is configured to:

in a case where the specified trajectory does not match the reference trajectory,

acquire an offset amount (offset amount ΔT) of the specified trajectory with respect to the reference trajectory from the trailer image; and

add a correction value (correction value Δφ) corresponding to the offset amount to the angle determined according to the position of the detection object on the specified trajectory, in the slope correction.

According to the vehicle of the above (2), the relative yaw angle corresponding to the inclination of the road surface on which the trailer is located relative to the road surface on which the vehicle is located can be effectively corrected.

(3) The vehicle according to the above (1),

in which the camera further acquires a surrounding image of the vehicle and the trailer, and

the processor is configured to:

generate a vehicle prediction trajectory and a trailer prediction trajectory based on the travel state information and the relative yaw angle;

generate a display image (display image IMG2) in which the vehicle prediction trajectory and the trailer prediction trajectory are superimposed on the surrounding image; and

perform display processing of displaying the display image on a display device (touch panel display 22).

According to the vehicle of the above (3), the trailer prediction trajectory can be effectively presented to an occupant of the vehicle in combination with the improvement in the estimation accuracy of the relative yaw angle.

(4) The vehicle according to the above (3),

in which the processor is configured to make different display modes of the trailer prediction trajectory in the display image between a case where the trailer prediction trajectory is generated based on the relative yaw angle subjected to the slope correction and a case where the trailer prediction trajectory is generated based on the relative yaw angle not subjected to the slope correction.

According to the vehicle of the above (4), by changing the display mode of the trailer prediction trajectory in the display image based on the presence or absence of the slope correction, it is possible to call the attention of the occupant of the vehicle regarding that the road surface on which the trailer is located is inclined relative to the road surface on which the vehicle is located, and it is possible to urge the occupant to perform careful steering.

(5) The vehicle according to the above (3),

in which the processor is configured to, in a case of generating the trailer prediction trajectory based on the relative yaw angle subjected to the slope correction, perform notification processing of notifying an occupant of the vehicle that the trailer prediction trajectory is generated based on the relative yaw angle subjected to the slope correction.

According to the vehicle of the above (5), it is possible to call the attention of the occupant of the vehicle regarding that the road surface on which the trailer is located is inclined relative to the road surface on which the vehicle is located, and it is possible to urge the occupant to perform careful steering.

(6) The vehicle according to the above (1),

in which the detection object has a grid pattern including one or more grid points, and

the processor is configured to extract the one or more grid points from the trailer image as a feature of the detection object.

(7) A method of estimating a relative yaw angle (relative yaw angle φ) of a trailer (trailer 2) relative to a vehicle (vehicle 1) towing the trailer,

in which a processor (ECU 70) performs the method including :

causing a camera (rear camera 11Rr) provided in the vehicle to acquire a trailer image (IMG1) containing a detection object (marker 7) provided on the trailer;

causing a sensor (wheel sensor group 13, steering angle sensor 31) provided in the vehicle to acquire travel state information of the vehicle; and

estimating the relative yaw angle based on at least one of the trailer image or the travel state information, and

in which in the estimation of the relative yaw angle based on the trailer image, the processor performs:

specifying a trajectory (trajectory T) of the detection object, which moves according to a change in the relative yaw angle, in the trailer image;

determining whether the specified trajectory matches a predetermined reference trajectory (reference trajectory T₀);

in a case where the specified trajectory matches the reference trajectory, estimating an angle determined according to a position of the detection object on the trajectory, as the relative yaw angle; and

in a case where the specified trajectory does not match the reference trajectory, determining that a second road surface on which the trailer is located is inclined relative to a first road surface on which the vehicle is located, and estimating, as the relative yaw angle, an angle obtained by performing slope correction on an angle determined according to a position of the detection object on the specified trajectory.

According to the method of the above (7), the estimation accuracy of the relative yaw angle can be improved.

(8) A non-transitory computer-readable storage medium storing a program causing a processor to perform the method of the above (7).

What is claimed is:

1. A vehicle for towing a trailer, the vehicle comprising:
a camera configured to acquire a trailer image containing a detection object provided on the trailer;
a sensor configured to acquire travel state information of the vehicle; and
a processor configured to estimate a relative yaw angle of the trailer relative to the vehicle, based on at least one of the trailer image or the travel state information,
wherein in the estimation of the relative yaw angle based on the trailer image, the processor is configured to:
specify a trajectory of the detection object, which moves according to a change in the relative yaw angle, in the trailer image;
determine whether the specified trajectory matches a predetermined reference trajectory;
in a case where the specified trajectory matches the reference trajectory, estimate an angle determined according to a position of the detection object on the trajectory, as the relative yaw angle; and
in a case where the specified trajectory does not match the reference trajectory, determine that a second road surface on which the trailer is located is inclined relative to a first road surface on which the vehicle is located, and estimate, as the relative yaw angle, an angle obtained by performing slope correction on an angle determined according to a position of the detection object on the specified trajectory.

2. The vehicle according to claim 1,
wherein the reference trajectory is a trajectory of the detection object, which moves according to the change in the relative yaw angle, in the trailer image when a relative pitch angle of the trailer relative to the vehicle is 0°, and
the processor is configured to:
in the case where the specified trajectory does not match the reference trajectory,
acquire an offset amount of the specified trajectory with respect to the reference trajectory from the trailer image; and
add a correction value corresponding to the offset amount to the angle determined according to the position of the detection object on the specified trajectory, in the slope correction.

3. The vehicle according to claim 1,
wherein the camera further acquires a surrounding image of the vehicle and the trailer, and
the processor is configured to:
generate a vehicle prediction trajectory and a trailer prediction trajectory based on the travel state information and the relative yaw angle;
generate a display image in which the vehicle prediction trajectory and the trailer prediction trajectory are superimposed on the surrounding image; and
perform display processing of displaying the display image on a display device.

4. The vehicle according to claim 3,
wherein the processor is configured to make different display modes of the trailer prediction trajectory in the display image between a case where the trailer prediction trajectory is generated based on the relative yaw angle subjected to the slope correction and a case where the trailer prediction trajectory is generated based on the relative yaw angle not subjected to the slope correction.

5. The vehicle according to claim 3,
wherein the processor is configured to, in a case of generating the trailer prediction trajectory based on the relative yaw angle subjected to the slope correction, perform notification processing of notifying an occupant of the vehicle that the trailer prediction trajectory is generated based on the relative yaw angle subjected to the slope correction.

6. The vehicle according to claim 1,
wherein the detection object has a grid pattern including one or more grid points, and
the processor is configured to extract the one or more grid points from the trailer image as a feature of the detection object.

7. A method of estimating a relative yaw angle of a trailer relative to a vehicle towing the trailer,
wherein a processor performs the method comprising:
causing a camera provided in the vehicle to acquire a trailer image containing a detection object provided on the trailer;
causing a sensor provided in the vehicle to acquire travel state information of the vehicle; and
estimating the relative yaw angle based on at least one of the trailer image or the travel state information, and
wherein in the estimation of the relative yaw angle based on the trailer image, the processor performs:
specifying a trajectory of the detection object, which moves according to a change in the relative yaw angle, in the trailer image;
determining whether the specified trajectory matches a predetermined reference trajectory;
in a case where the specified trajectory matches the reference trajectory, estimating an angle determined according to a position of the detection object on the trajectory, as the relative yaw angle; and
in a case where the specified trajectory does not match the reference trajectory, determining that a second road surface on which the trailer is located is inclined relative to a first road surface on which the vehicle is located, and estimating, as the relative yaw angle, an angle obtained by performing slope correction on an angle determined according to a position of the detection object on the specified trajectory.

8. A non-transitory computer-readable storage medium storing a program causing a processor to perform the method according to claim 7.
